(19) United States
(12) Patent Application Publication
(10) Pub. No.: US 2008/0173257 A1
(43) Pub. Date: Jul. 24, 2008

(54) Animal control apparatus and methods

(76) Inventors: Michael Steiner, San Diego, CA (US); Pattie Steiner, San Diego, CA (US)

Correspondence Address: GAZDZINSKI & ASSOCIATES, 11440 WEST BERNARDO COURT, SUITE 375, SAN DIEGO, CA, 92127, US

(21) Appl. No.: 11/655,306

(22) Filed: Jan. 18, 2007

(51) Int. Cl. A01K 27/00

(52) U.S. Cl. 119/796; 222/3; 362/113

(57) ABSTRACT

Apparatus and methods for animal control and restraint. In one embodiment, the apparatus comprises a retractable tether (e.g., leash) having a single-handed grip handle which include a built-in chemical repellent. The handle further includes a mechanism for quickly dispensing chemical repellent directionally by initiating a safety and actuating a trigger mechanism. The repellant can be used to rapidly spray one or more animals (such as during a dogfight) so as to minimize physical trauma to the dogs, and emotional trauma to the owner(s). Also, the handle is optionally equipped with a built in light for effective use of the handle (and repellant) in the dark, as well as a retractable mechanism to manage the dispensing and storage of a leash that can be attached to an animal collar.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The invention pertains generally to apparatus and methods for restraining and otherwise controlling animals, and particularly in one exemplary aspect to a leash apparatus with integral control and security apparatus.

2. Description of Related Technology

A broad variety of different approaches to animal control and restraint are evidenced in the prior art. One such device is the leash, which can be no more than a rope, although increasingly sophisticated variants have emerged over time.

A common variant of the leash now in use is the retractable leash, which in effect uses a spool or reel of leash or tether material (typically a flat nylon or synthetic mesh material of high comparative strength and low weight) that can be easily payed out or retrieved. This allows the user to, inter alia, dynamically adjust the length of the leash during use.

Other variants of the leash include lighting, facility for storage, security alarms, etc. For example, U.S. Pat. No. 5,214,411 to Herbruck issued May. 25, 1993 entitled “Ultrasonic animal repelling apparatus” discloses an ultrasonic sound emitting apparatus that produces an undesirable noise for animals such as dogs and cats to deter such animals from trespassing within certain geographical locations with this noise being of such a high frequency level that it is not heard by most human beings. The apparatus includes a housing with an ultrasonic emitter being mounted within a reflector cone formed within the front face of the housing. The sound emitter is moveable relative to the cone between a projected position and a retracted position and when in the retracted position the pattern of sound emitted is substantially wider than when the emitter is in the projected position. With the emitter in the projected position the pattern of sound emitted is of substantially greater length than the pattern of sound with the emitter in the retracted position. A sensor such as an infrared sensor is to be mounted within the front face of the housing which will cause activation of the emitter only upon an animal being detected.

U.S. Pat. No. 5,429,075 to Passarella, et al. issued Jul. 4, 1995 entitled “Pet leash and flashlight combination apparatus” discloses a combination leash apparatus for controlling the movements of an animal and retaining a flashlight includes a flexible elongate member having a first end and a second end, and a collar engagement structure at the first end and a handle portion at the second end; and a tubular retaining member attached to the elongate member for removably retaining a flashlight. The apparatus preferably additionally includes a supplemental compartment secured to the tubular retaining sleeve for retaining personal items. The elongate member preferably additionally includes a flat, flexible strap member. The collar engagement structure preferably includes a resiliently urged clasp assembly. The handle portion preferably includes a loop formed of the second end of the elongate member doubled back against and fastened to the elongate member. The tubular retaining member preferably includes a closed end having an end wall and an open end for receiving the flashlight. The tubular retaining member preferably additionally includes a switch port located to register with and provide access to a slide switch on a flashlight. The apparatus also preferably includes a hook and loop fastener for removably attaching the tubular retaining member to the elongate member. The tubular retaining member is preferably attached to the elongate member at the handle portion. The compartment includes an access opening. The access slit is preferably closed with a fastener. The compartment may be secured to the tubular retaining member.

U.S. Pat. No. 5,558,044 to Nasser, Jr., et al. issued Sep. 24, 1996 entitled “Illuminated dog leash handle” discloses an illuminated animal leash which enables a user to hold a dog leash and direct a flashlight beam easily with one hand. The leash assembly includes a handle having a grip portion and a flashlight portion. A leash having a loop at one end is connectable to the handle by a connecting mechanism which allows the loop of the leash to be removable connected to the handle. Possible connecting mechanisms include a pivotable member, a snap in connection or a clip type connection. The leash may also be permanently attached to the handle as in the case of a retractable leash. The handle is preferably provided with a handle which extends at approximately a 90 degree angle to the beam of light emitted by the flashlight.

U.S. Pat. No. 5,718,192 to Sebastian issued Feb. 17, 1998 entitled “Leash and attached carrying bag” discloses an animal waste carrying bag and leash for carrying articles such as pet waste, waste retrieval articles, bags, and personal belongings. The carrying bag may be attached to the pet leash or carried by hand. A name plate on the carrying bag provides identification of the owner and a fluorescent strip on the carrying bag provides for safer walking at night.

U.S. Pat. No. 5,762,029 to DuBois, et al. issued Jun. 9, 1998 entitled “Combined retractable leash and flashlight” discloses an apparatus having a retractable leash and an integral light. The apparatus has a first housing section and a retractable leash section. The first housing section has a handle, a light connected to top front portion of the first housing section and a receiving area. A rechargeable battery is removably connected to the first housing in the handle. The retractable leash section has a second housing section pivotably mounted to the first housing section, in the receiving area, and a reel rotatably mounted to the second housing section. A leash is connected to the reel for extension and retraction relative to the first housing section. In an alternate embodiment, a light is located on the leash and electrically connected to a conductor extending along the leash.

U.S. Pat. No. 5,887,550 to Levine, et al. issued Mar. 30, 1999 entitled “Combined retractable pet leash and flashlight” discloses a combined pet leash and flashlight comprising a mechanical dispensing and retracting cord for the purpose of tethering, restraining and controlling a pet during a walk. The device may also include a coin holder/dog waste bag holder, slot/compartment, a key holder, a key ring/or storage compartment, flashing LED version, whistle, pepper spray, wrist mounted version flashlight feature as examples.

U.S. Pat. No. 5,967,095 to Greves issued Oct. 19, 1999 entitled “Illuminated pet leash” discloses an illuminated pet leash which includes an elongated strap having at least one side, a first end adapted for connection to a collar, and a second end forming a handle. A relatively flat and flexible light source is provided along one side of the strap for illuminating the leash. The light source is operated by a power source attached to the strap. The light source may be either permanently or releasably attached to the strap. In another embodiment, the elongated leash strap has first and second sides, and two light sources extend along both sides. In yet another embodiment, the elongated strap is round in cross-section, and the light source spirals around the circumference of the strap for the extent of the leash. In another embodiment, the illuminated pet leash includes an elongated strap having at least one side, and first and second ends. One end of the strap is attached to a handle having a grip portion and a housing portion with first and second sides. A pair of light sources are positioned on the sides of the housing, and are electrically connected to a power source to illuminate the handle. The pair of light sources are either attached directly to the handle, or to a cover that is attached to the handle. The light sources on the handle or cover are formed in a variety of patterns such as circular, spiral or zig-zag.

U.S. Pat. No. 6,019,067 Carey issued Feb. 1, 2000 entitled “Animal restraint storage receptacle” discloses an article-carrying receptacle for attachment to a leash that includes a body portion for holding articles placed therein while providing access to the contents thereof by a free hand of the individual holding the handle portion of the leash in a remaining hand. The receptacle is supportingly securable to the leash for use in a manner permitting one-hand operation of the entry closure by the free hand. In an advantageous embodiment the receptacle body portion is in the form of an elongated pouch, receivable in a position proximal a handle portion of a leash, or mounted directly thereto, in the longitudinal direction. A closable opening is conveniently provided along the length of the receptacle for accessing the interior thereof, positioned to provide access by a free hand of the individual. In another embodiment, a combination of a receptacle, and a handle portion of a leash on which the receptacle is received includes a triangularly configured handle portion, advantageously having the shape of either a substantially isosceles or substantially right triangle.

U.S. Pat. No. 6,371,055 to Lawrence issued Apr. 16, 2002 entitled “Leash” discloses a dog leash which incorporates a personal security device. The dog leash includes a handle with an ergonomically shaped body that is also padded to. facilitate comfort of use. Disposed substantially inside a substantially watertight cavity defined by the handle is a personal security device. In one embodiment, the personal security device includes an audible alarm, a battery, and an activation switch selectively operated by the user so as to activate the audible alarm. A hand loop is connected to one end of the body so that when a user's hand is inserted through the hand loop the user's hand may thereby grasp the ergonomically shaped body, and be proximately disposed with respect to the activation switch of the personal security device. A snap swivel is attached to the other end of the ergonomically shaped body, and a split ring depending from the snap swivel removably engages one end of a lead. The other end of the lead has a coupler for attaching the lead to a dog collar.

U.S. Pat. No. 7,044,080 to Rabello issued May 16, 2006 entitled “Dog leash handle” discloses a multi-compartmented dog leash handle assembly. The handle assembly has a compartment capable of carrying keys, money and/or plastic waste bags. The handle also has provisions for the easy transport of dog food and water. The handle also has a mechanism for attaching to the loop handle of a typical dog leash.

United States Application Publication No. 20060027187 to Nicastro published Feb. 9, 2006 entitled “Pet utility belt” discloses a pet utility belt including at least one compartment configured to receive items related to a dog walk and at least one clip for attachment of an item, such as a dog leash. During operation, the wearer of the belt can quickly put the belt on when he/she is ready to go out. The compartments can be pre-filled with specific items so that no additional time is spent gathering the necessary items for dog walking, such as, treats to reward the dog, bags to pick up the dog's waste, a flashlight for dusk or nighttime walking, especially around dark neighborhoods or parks, mace for possibly defending oneself against stray dogs, an umbrella in case it starts raining or the weather is bad, a wallet to hold money to allow the wearer the ability to buy sundries for themselves or the dog.

Despite the foregoing variety of leash and tether configurations, none are effective at addressing the issue of separating animals which are fighting or otherwise engaged in undesired behavior. As is well known, many animals (including especially canines) will engage in fierce combat, which in many cases may be to the death. This combat may include one or both of the animals “locking” their jaws onto the other animal, in effect a death-grip. Separating such animals during such combat can be not only dangerous (since the animal(s) may snap or attack the human attempting to separate them), but may also require extreme amounts of force that the user may not possess. Moreover, one of the animals may be rabid (which may induce the attack or fighting in the first place), which can expose the owner to extreme health risk if they try to separate the animals.

In addition to physical hazards, the sight of two animals fighting (especially where there is a significant disparity in their size and strength) may be emotionally traumatic for the user, perhaps watching their favorite pet being literally torn apart by a large dog, coyote, rabid raccoon, etc. The feeling of helplessness in such a case is pervasive and significant, and may stay with the owner for the rest of their life.

Hence, there is a salient need for improved apparatus and methods for animal control and restraint that address the issue of, inter alia, fighting or otherwise engaged animals. Such improved apparatus and methods would ideally allow for the user to maintain restraint of their own animal(s) if desired, while also readily and rapidly implementing one or more security or control features to accomplish a desired function (e.g., dispensing a chemical agent to separate the fighting or engaged animals) while also maintaining a safe distance there from. In the case of the aforementioned chemical agent, the improved apparatus and methods would also ideally allow for the user to rapidly orient and activate the apparatus so as to dispense the agent on target immediately, thereby avoiding fumbling to remove an agent dispenser from a pocket or other holder as in the prior art described above, which may feasibly make the difference between life and death for their pet. Ancillary features and capabilities such as lighting (e.g., flashlight), storage compartments, and the like would also ideally be compatible with the improved apparatus and methods.

### SUMMARY OF THE INVENTION

In a first aspect of the invention, improved control and restraint apparatus is disclosed. In one embodiment, the apparatus comprises a housing with a retractable tether (on an internal spool) as well as an internally carried chemical agent such as pepper spray or mace. The chemical agent is selectively dispensed by the user via a spray nozzle that points generally in the direction of the payed-out tether. The apparatus also comprises a “pistol grip” portion and accessible trigger and safety mechanisms to allow the user to restrain the tethered animal and dispense the chemical agent all with one hand.

In a second embodiment, the aforementioned housing comprises an electrical power source (e.g., batteries, hand-crank magneto, etc.) to support electrical functions including lighting, audible alarm, etc.

In still another embodiment, the apparatus comprises a simplified pistol-grip like housing with a tether threaded through and captured therein. The housing further includes the chemical agent dispenser within the pistol grip portion.

In a second aspect of the invention, a method of using a control and restraint apparatus is described. In one embodiment, the method comprises restraining an animal using the apparatus, and selectively discharging a chemical agent during such restraint so as to accomplish a function; e.g., separating two fighting dogs.

In a third aspect of the invention, a method of manufacturing the control and restraint apparatus is disclosed.

In a fourth aspect of the invention, animal control apparatus is disclosed. In one embodiment, the apparatus comprises: a tether for at least partly restraining an animal; a handle element coupled to the tether; and a deterrent mechanism, said deterrent mechanism being detachable from the handle element and adapted for substantially continuous dispensing of a chemical agent.

In one variant, the substantially continuous dispensing comprises continuous dispersal of atomized chemical agent from a pressurized canister until the canister is substantially emptied, said continuous dispersal continuing without further human action after initiation thereof.

In another variant, the deterrent mechanism further comprises at least one of: (i) a concussive charge; and (ii) a high-intensity luminous flash apparatus.

### BRIEF DESCRIPTION OF THE DRAWINGS

The features, objectives, and advantages of the invention will become more apparent from the detailed description set forth below when taken in conjunction with the drawings, wherein:

FIG. 1 provides front side and lavational views of a first exemplary embodiment of the control and restraint apparatus with a built in compartment for a chemical agent, according to the invention.

FIG. 1a is a side elevation view of the control and restraint of FIG. 1, illustrating various internal features thereof.

FIG. 1b is a side elevation view of a second exemplary embodiment of the control and restraint apparatus having a pump spray mechanism, according to the invention.

FIG. 1c is an overhead graphical illustration of use of the control and restraint apparatus according to the invention, illustrating the self-alignment feature thereof.

FIG. 1d is side elevation view of an exemplary embodiment of the control and restraint apparatus having a light mechanism and battery compartment.

FIG. 1e is a side elevation view of another exemplary embodiment of the control and restraint apparatus according to the invention, wherein the chemical agent canister is disposed in the upper portion of the housing.

FIG. 1f is a side elevation view of still another exemplary embodiment of the control and restraint apparatus having a user-adjustable spray nozzle.

FIG. 1g is a side elevation view of yet another exemplary embodiment of the control and restraint apparatus having a (web) storage device for storage of additional or replacement canisters.

FIG. 1h is a side elevation view of another exemplary embodiment of the control and restraint apparatus according to the invention, comprising a single handle with threaded tether and internal canister.

FIG. 1i is a side elevation view of still another exemplary embodiment of the control and restraint apparatus according to the invention, comprising a single handle with triangulated tether and internal canister.

FIG. 1j is a top perspective view of another exemplary embodiment of the control and restraint apparatus according to the invention, comprising a single round cross-section handle with threaded tether and internal canister.

FIG. 2 is a logical flow diagram illustrating one exemplary embodiment of the method of use of the control and restraint apparatus of the invention.

FIG. 3 is a logical flow diagram illustrating one exemplary embodiment of the method of manufacturing the control and restraint apparatus of the invention.

### DETAILED DESCRIPTION OF THE PREFERRED EMBODIMENT

Reference is now made to the drawings wherein like numerals refer to like parts throughout.

As used herein, the term “leash” refers generally to, without limitation, any mechanism attached to the neck or other portion of an animal for restraint or control, such as e.g., ropes, retractable leashes or tethers, harnesses, and even electronic devices (such as “electronic dog fences”).

As used herein, the term “animal” refers generally to any ambulatory non-human species including, without limitation, canines, felines, wolf hybrids, and simians.

As used herein, the term “chemical agent” refers generally to any chemical, physical, or other substance that when dispensed, has a desired effect including, without limitation, repellants such as pepper spray, white pepper spray, “mace”, PAVA, pelargonic acid morpholide, Citronella, and so forth.

### Overview

The present invention comprises methods and apparatus useful for controlling and restraining animals. In one embodiment, the apparatus comprises a handle apparatus capable of dispensing a chemical agent that can be actuated and used by an individual with one hand if needed. The exemplary apparatus allows for both restraint of one or more animals via, e.g., a leash or tether, as well as rapid and directional dispensing of the agent; e.g., a repellant such as to neutralize or separate two or more fighting or otherwise engaged dogs, neutralize an uncontrollable or demented pet, or neutralize an attacker (animal or human).

One salient aspect of the exemplary embodiment is that the user can direct the discharge of the chemical agent (e.g., repellant) in a desired direction while also maintaining the restraint function of the apparatus substantially intact. Specifically, the user can, with one hand, both point and actuate the dispensing mechanism (e.g., trigger and safety) while keeping their animal(s) tethered.

Moreover, other optional features (including lighting, audible alarm, etc.) can be readily actuated by the user with the same hand. The user's hand is also substantially protected from the spray effluent by the housing of the apparatus.

### Description of Exemplary Embodiments

### Apparatus—

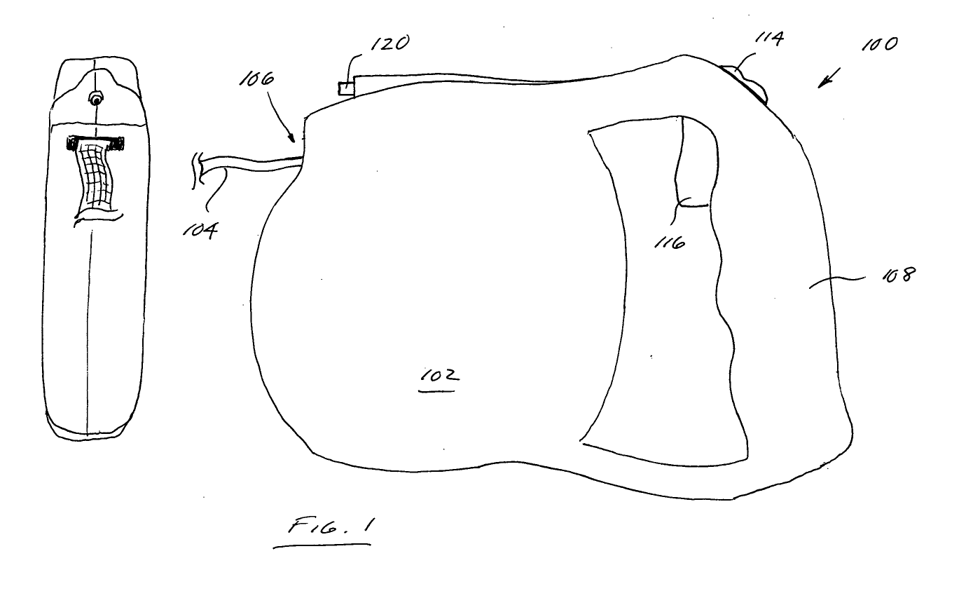

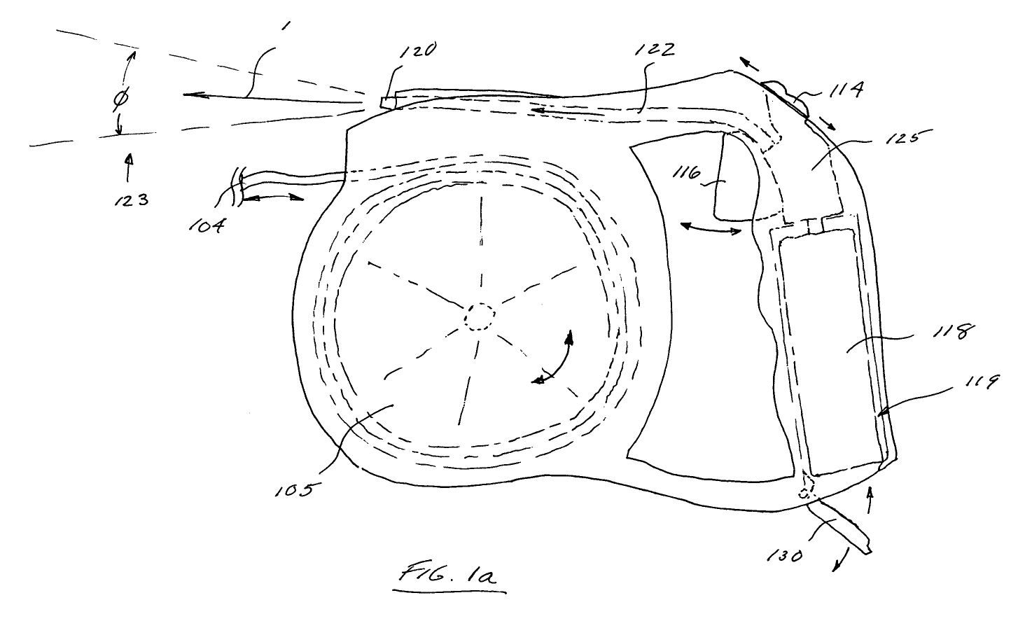

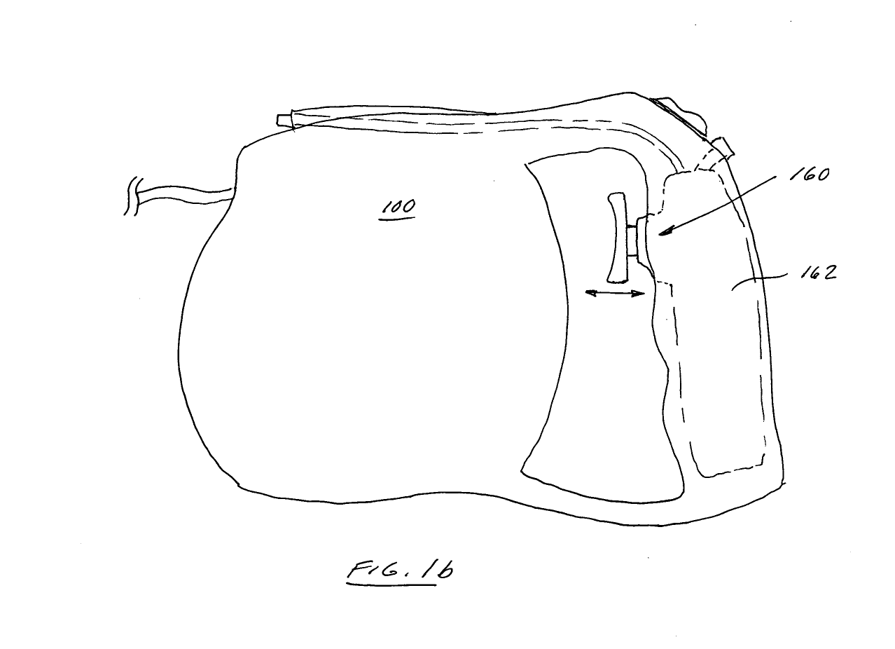

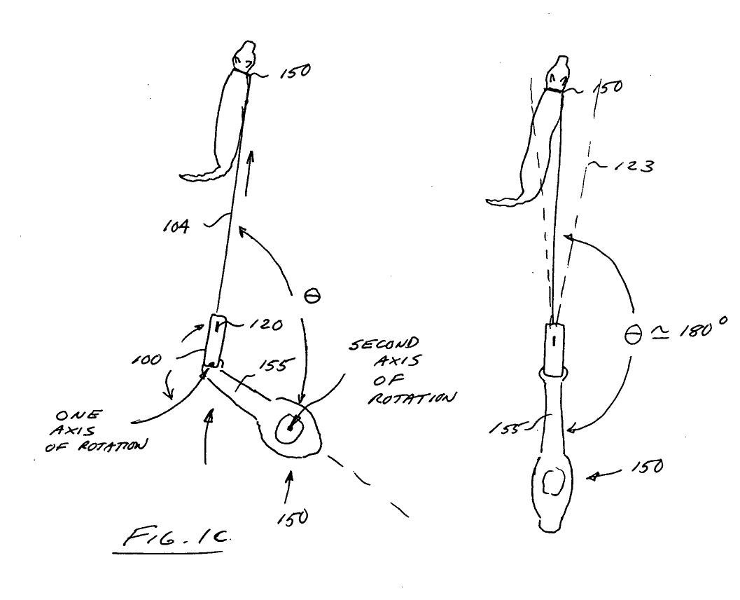

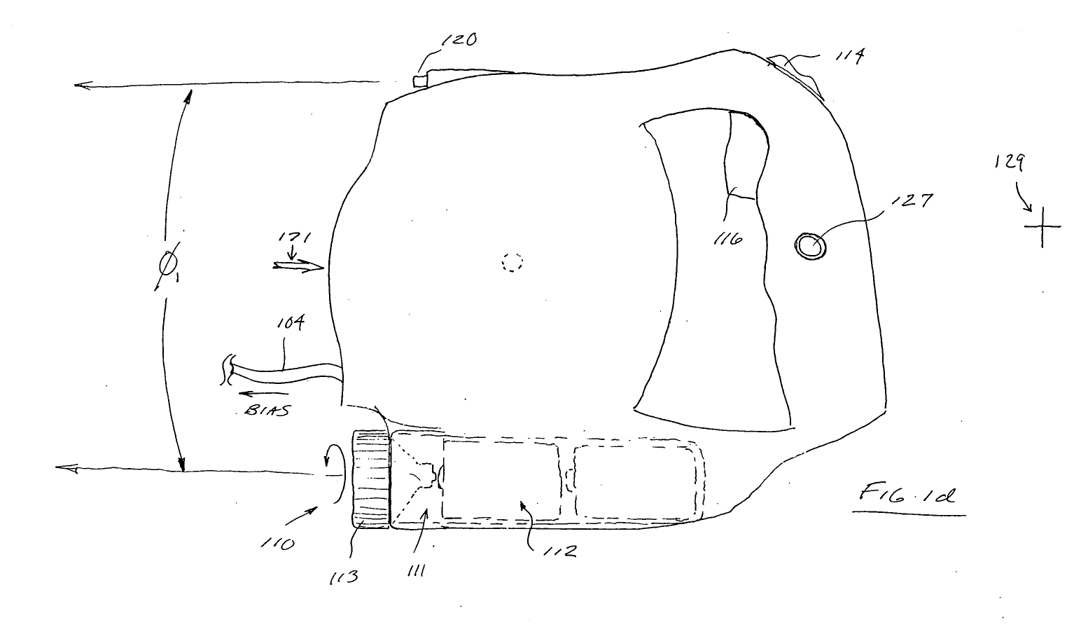

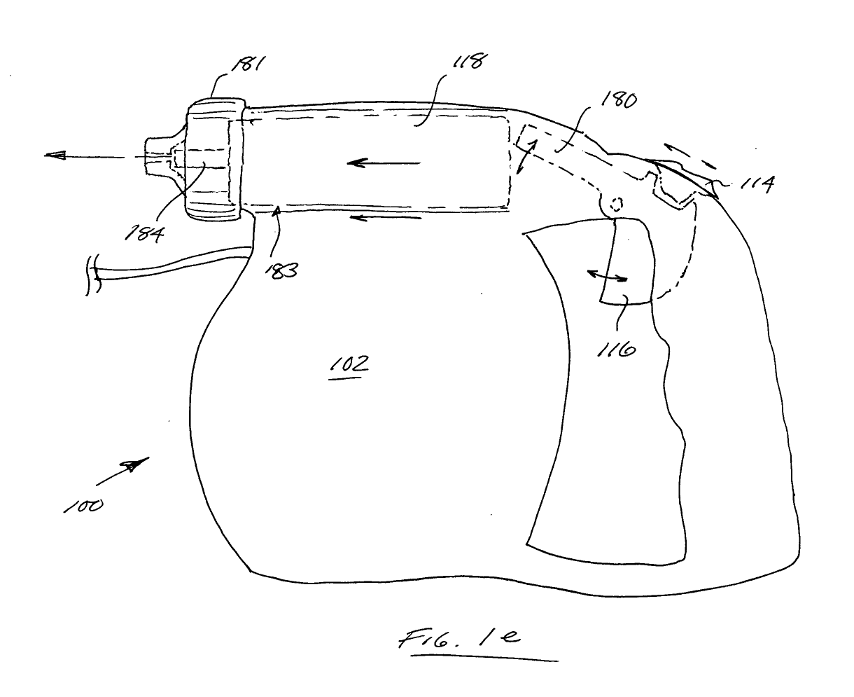

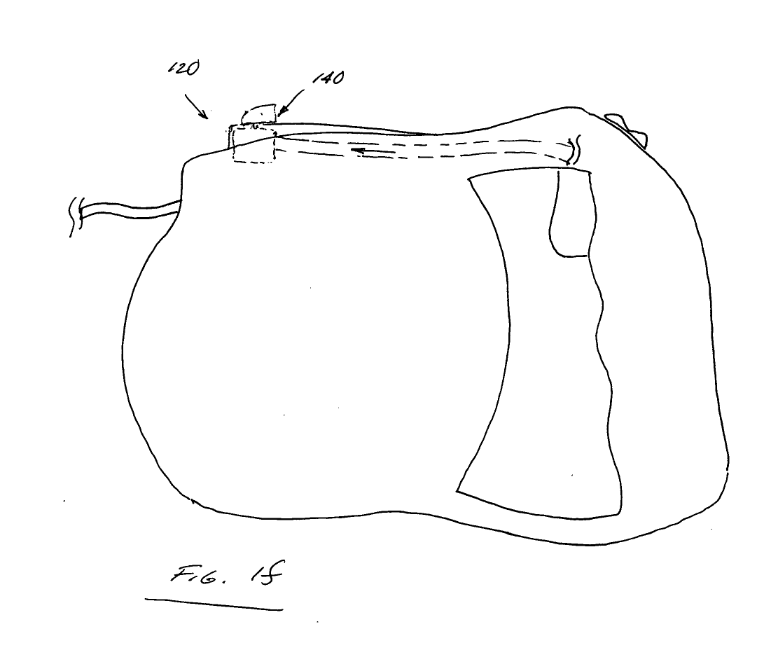

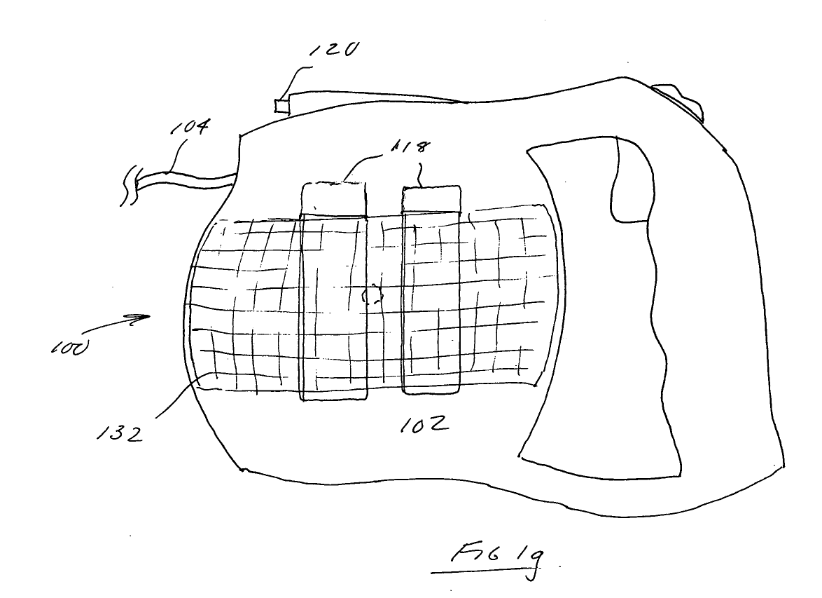

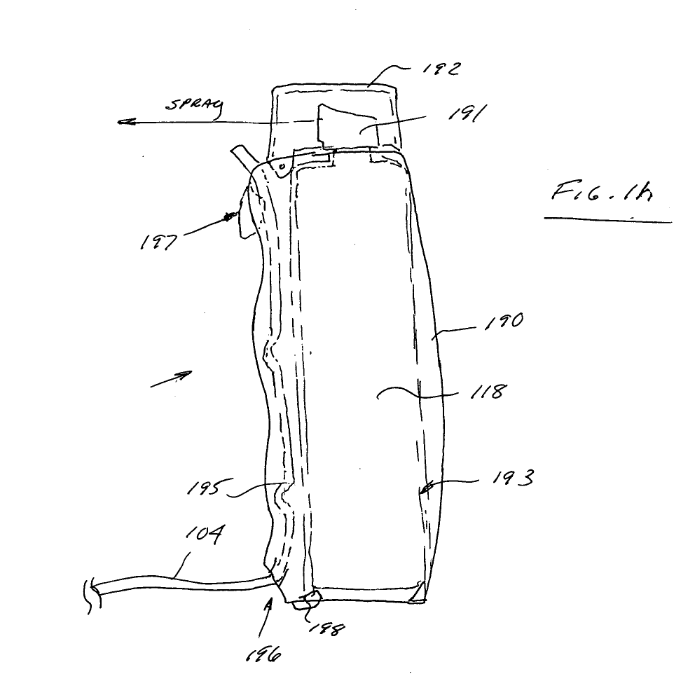

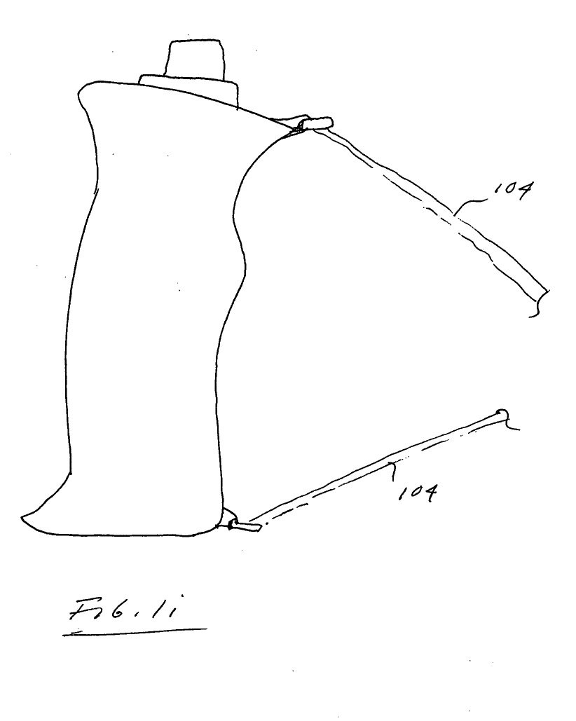

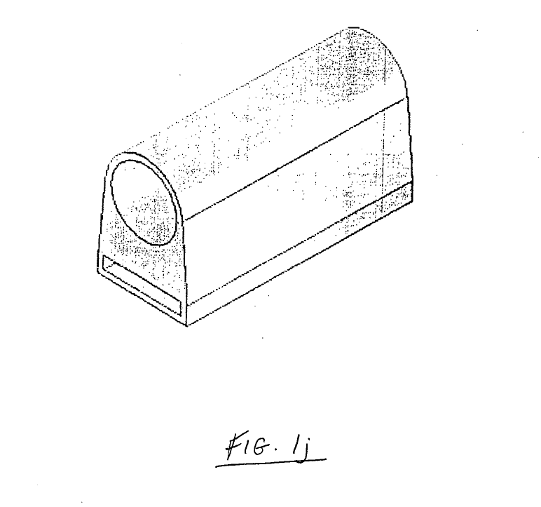

Referring now to FIGS. 1-1h, exemplary embodiments of the control apparatus of the invention are described in detail. It will be appreciated that while described generally in the context of an animal control and restraint apparatus, other applications are possible.

As shown in FIGS. 1 and 1a, a first embodiment of the control apparatus 100 comprises a retractable leash or tether 104 contained substantially within an exterior casing or housing 102 (when retracted) and disposed on a spool or other storage mechanism 105. The housing 102 of the illustrated embodiment comprises a two-piece construction (split longitudinally, as best shown in FIG. 1) having built-in or integral hand-held grip 108 to be grasped by the user. The illustrated apparatus further comprises a safety 114 and trigger 116 built-in chemical repellent 118.

The illustrated housing is formed from a molded polymer (e.g., injection or transfer-molded plastic or the like) for low cost and low weight, as well as substantial impact resistance, although other materials may be used if desired. For example and without limitation, the housing 102 may comprise a lightweight metallic alloy. The housing components may be snap-fit, held together by fasteners (e.g., screws), held together by adhesives, or any combination or permutation of the foregoing.

The exemplary leash or tether comprises one of substantially flat cross-section (not shown) to permit space-efficient spooling onto the spool 105 (which rotates within the housing when paying out or retrieving the tether), although it will be appreciated that other types and cross-sections (e.g., round, oval, etc.) of tether may be used consistent with the invention. The spool 105 also comprises a stop or brake mechanism (not shown) which allows the user to selectively adjust and maintain a desired tether length.

The tether material of the present embodiment comprises a strong synthetic (e.g., nylon) web material common to e.g. dog leashes, baggage handles, parachute equipment, etc. Such material is well known and accordingly not described further herein. The one or more tether(s) may also vary in color, texture, reflectivity, fluorescence or luminescence, etc. both across multiple tethers, or within the same one. As an example of the latter, the tether might comprise three (3) colors (e.g., green, yellow and red), corresponding to the amount of tether payed out. This lets the user know in a rough sense the radius of the animal from the apparatus 100, thereby allowing them to gauge how effective the chemical agent dispensation will be. For example, red might indicate that the animal is out of range of the spray nozzle if the tether is biased to its full length, whereas yellow might indicate the fringe of the effective range, while green would indicate that the animal was within range. This might also prompt the user to adjust the nozzle metering profile (see discussion of FIG. 1f supra). It is also recognized that such adjustment may be implemented automatically; e.g., wherein the amount of tether dispensed or payed out is sensed, such as via a rotation or other sensor within the apparatus 100, and the metering of the nozzle automatically adjusted based thereon (i.e., for range). A programmable logic device (PLD), microcontroller, FPGA, ASIC, DSP, or any other such device well known in the art can be used to provide such control based on input from the tether sensor.

The apparatus 100 further comprises an internal reservoir of a chemical agent (e.g., repellant), which can be selectively dispensed by the user. One exemplary embodiment of the apparatus comprises a pressurized gas/liquid cylinder 118 of the type well known in the personal security arts. Advantageously, the handle apparatus 100 may further be adapted to use off-the-shelf chemical repellant cylinders, thereby avoiding the need for a specialized configuration. In one variant, the user can simply remove the cap and dispensing nozzle that comes with the off-the-shelf device (exposing the cylinder dispensing valve or tube, generally positioned in the top center of the cylinder), and insert the canister into the receiving chamber 119 in the handle apparatus. The exposed cylinder tube interfaces with the dispensing valve 125 (FIG. 1a), the latter porting the expelled chemical agent out the spray nozzle 120 via the spray tube 122 after the safety interlock and trigger 116 are actuated as described subsequently herein. Advantageously, the valve 125, tube 122, and trigger and safety mechanisms 116, 114 can each be fashioned from injection or transfer-molded plastic or other low cost material.

The cylinders or canisters 118 can also be labeled with appropriate information (e.g., security number, date of manufacture, contents, MDS hazard information, etc.) for purposes of tracking and control.

A hinged or removable cover door 130 (FIG. 1a) is optionally provided to, inter alia, maintain the cylinder 118 from falling out of the apparatus 100, and protect against intrusion of moisture, dirt, etc. The cylinder may also be spring-loaded; i.e., biased outward from the apparatus by an internal spring (not shown) that is compressed by the placement of the door 130 by the user, engagement of an internal locking means, and so forth.

Alternatively, however, the handle apparatus can be configured to require a unique or proprietary configuration of cylinder, thereby helping assure quality, since the broader the range of third-party manufacturers whose products can be used with the apparatus, the greater the chance that a defective or sub-standard aftermarket device might be use with the apparatus. Using the proprietary scheme, only licensed producers can make the cylinders, and hence quality and manufacturing standards much more easily maintained.

It will also be appreciated that the handle apparatus may be fitted with an internal reservoir or tank that is designed to be recharged in situ; e.g., from an external pressurized source via a recharge valve (e.g., one-way valve; not shown) in communication with the reservoir. This approach obviates the use of disposable cylinders or canisters, but does require an external apparatus for recharging the apparatus periodically or after use.

In one embodiment, the actuation (and hence dispensation) of the repellant is accomplished via a dual-actuation trigger mechanism (see FIG. 1a). Specifically, this mechanism comprises (i) a trigger mechanism 116 for initiating dispensing of the repellant, and (ii) a safety mechanism 114 which is mechanically or electrically interlocked with the trigger mechanism so as to prevent dispensing of the repellant via the dispending valve 125 unless both mechanisms (trigger and safety) are actuated simultaneously. This approach is similar to that found on conventional fireplace or butane lighters, and prevents inadvertent ignition (here dispensation) and possible injury or depletion of the repellant. It will be appreciated, however, that such a safety or interlocked mechanism is not required to practice the present invention.

Moreover, other types of safety mechanisms can be used including, e.g., a trigger block (akin to that used on rifles or shotguns), which physically prevents the trigger from moving (versus preventing actuation of the dispensing valve 125) until the safety mechanism is actuated.

The trigger can also optionally be equipped with a lock, allowing it to be held in the depressed or actuated position without further user action once actuated, thereby allowing the entire contents of the canister to be expelled in one shot.

In another embodiment (FIG. 1b), a manual source of pressurization can be used, such as a pump trigger 160 (generally similar to that used on a child's water pistol), or squeeze grip. This approach obviates the use of a pressurized cylinder or canister, or tank as previously described, and also prevents situations where the canister is inadvertently de-pressurized (or completely depleted during extended use). It does, however, necessitate refilling of the internal tank 162 of the apparatus (and handing of potentially noxious repellant chemicals). However, it will be appreciated that a combination of approaches can be used; e.g., where both a pressurized disposable cylinder and a backup internal tank (pump spray) are used within the same apparatus.

Moreover, it will be recognized that multiple pressurized cylinders or canisters can be used in tandem; e.g., to provide a larger dispensing rate, redundancy, etc.

In one embodiment, the repellant comprises so-called “pepper spray” (or white pepper spray) of the type now ubiquitous in the art. Alternatively, one or more of the well-known citronella-based agents may be used consistent with the invention. Mace may also be used for this purpose.

In still another embodiment, a synthetic analogue of capsaicin, pelargonic acid vanillylamide (desmethyldihydrocapsaicin), is used as the chemical repellant.

In still another variant, a version of pepper spray known as PAVA spray (typically in common use in England). Another synthetic counterpart of pepper spray, pelargonic acid morpholide, may be used as well. It will further be appreciated that combinations (whether combined prior to dispensing, or at time of dispensing) of the foregoing may be used as well consistent with the invention.

Literally any type of chemical substance useful for accomplishing a given purpose (e.g., repulsion, incapacitation, temporary blindness, creation of a foul odor, creation of noxious fumes that make breathing by the target uncomfortable or difficult, create a very cold or hot sensation (e.g., liquid nitrogen, compressed refrigerant, etc.), induce vomiting via e.g., ipecac or the like when sprayed into the dog's mouth, etc.) may be employed consistent with the present invention.

Moreover, acoustic deterrents may also be used; e.g., compressed air or gas and a mini “bull horn” of the type commonly found at sporting events which can create very loud and undesirable sounds, as well as drawing attention to the user's location. This latter air horn apparatus can also be used in conjunction with chemical repellants, so as to make the local environment highly unpleasant from both a chemical and auditory perspective. Alternatively, the apparatus can be configured to generate unpleasant high-sonic or ultrasonic (e.g., greater than 20 kHz) emissions akin to a dog whistle.

In one alternate embodiment, the repellant is selected to be effective against, inter alia, coyotes, which characteristically hunt in groups of two or more beginning at dusk (especially in the Western U.S.), and are especially fond of attacking small dogs.

In another embodiment, the repellant is selected to be effective against humans who might wish to attack or rob the user (such as during late-night dog walks). For example, “mace” can be used for this purpose. A user-actuated audible alarm (described below) may also be provided, such that the user can call attention to themselves rapidly.

During a typical use scenario (FIG. 1c), the user 150 would have the apparatus 100 grasped in one hand via the grip 108, with the tethered animal exerting a bias on the end of the tether 104, thereby placing the tether under at least some tension. Hence, the apparatus and therefore the user's arm 155 would be somewhat extended away from the user's body. In the event that the user's animal is attacked by another animal (or vice versa), the user knows that their animal (and hence the other animal) is proximate to the apparatus 100 based on the radius of the dispensed portion of the tether 104. Advantageously, if the animal is pulling or exerting any bias on the tether, the user's arm will be extended substantially in the direction of pull (see FIG. 1c).

Stated differently, the end of the tether 104 (connected to e.g., the animal's collar 150) will often reside in a comparatively small solid angle around the longitudinal axis of the user's extended or partly extended arm 155. This allows for rapid targeting of the user's animal (or the animal(s) with which the user's animal is engaged) since the dispensing nozzle or tube of the exemplary embodiment is generally co-linear with the user's extended arm (angle Θ in FIG. 1c), thereby tending to naturally point the apparatus in the direction of the animal. The greater the distance between the tether egress point 106 and the user's hand grip 108, the greater the leverage (rotational moment or torque) applied by the tethered animal around the vertical axis of the hand grip, and hence the greater the foregoing tendency to align the apparatus 100 in the general direction of the animal.

Accordingly, the user must perform little if any movement or alignment of the apparatus before dispensing the repellant, since the apparatus is very frequently already pointing in the correct direction to place the animal(s) within the spray pattern or solid angle 123 of the dispensing tip or nozzle 120. This self-aligning feature reduces the time between recognition of the need to dispense repellant and the actual emission of the repellant on target, especially as compared to pulling such a dispenser from the user's pocket or bag, pointing it at the target, and then initiating dispensation, with required subsequent adjustments required for ranging, windage, elevation, etc.

Moreover, the structure of the exemplary apparatus 100 allows the user to roll or move their wrist/arm relative to the animal(s) during dispensation, whether torsionally or otherwise), thereby allowing for the desired spray pattern or coverage, or to adjust for movements of the animals (or to clear the tether if in the way).

It will also be appreciated that the use of a dispensing nozzle/tube arrangement 120, 122 in the illustrated embodiment advantageously provides for enhanced range for the dispensed chemical agent as compared to other delivery platforms or modalities. For example, were the user to hold a typical can of pepper spray, aim it at the target, and dispense, the dissipation or spread (and hence loss) of the spray pattern as a function of distance is greater since there is not an extension tube 122 and nozzle 120. Hence, the illustrated embodiment is somewhat akin to a prior art spray can of lubricant or solvent that is provided with a small-diameter extension tube for the nozzle that is useful for more precise placement of the sprayed substance, which also incidentally has an increased range as compared to the same nozzle without the tube. This feature allows the user to remain at a safe (or at least safer) distance from the target(s) while dispensing the chemical agent, so as to avoid reprisals or lashing out by the animal(s) when sprayed with the agent.

In another embodiment, the apparatus tether is equipped with a quick-release or detachment mechanism (not shown), which allows the user to decouple the animal from the apparatus 100 rapidly. This detachment can be accomplished by, e.g., actuating a button, level, or other such mechanism, or any number of other techniques readily recognized and implemented by those of ordinary skill in the art. This feature might be used, for example, when the animal(s) are tangled in the tether(s), and the user desires to get a “clean shot” by releasing the tether from the apparatus. In the case of the retractable (e.g., spooled) tether 104, the release mechanism might simply let the entire spool free from the housing in order to decouple the two components, such as by letting the two sides of the spool rotational axis spindle slide from capture mechanisms within the housing. Alternatively, the mechanism might allow the tether to pay all the way out, thereby effectively detaching the two components. Moreover, the payout may be accompanied by release of the tether from its spool 105 completely, such as via release of a capture mechanism on the spool spindle/core. Myriad other approaches to separating the tether from the apparatus 100 will be appreciated by those of ordinary skill provided the present disclosure.

While shown herein in the configuration of a retractable tether or leash, it will also be recognized that use of such a retractable tether 104 is in no way a requirement for practicing the invention. For example, the apparatus may be fitted with a non-retractable tether, thereby economizing on size and weight of the apparatus.

In another embodiment of the apparatus 100 (FIG. 1d), an optional light 110 and associated battery compartment 111 are provided to use for added visibility in the evening or for use in dark locations (tunnels, unlighted garages, etc.). As shown in FIG. 1d, the exemplary embodiment comprises a battery compartment 111 housing one or more battery cells 112 in the lower portion of the apparatus 100. The light 110 comprises a low voltage (e.g., 3V, 6V, or 12V depending on battery configuration) or similar lantern bulb that is affixed within a screw-on cap 113, akin to a prior art flashlight; Alternatively, one or more “white light” or similar diodes (LEDs) can be used as the light source for the apparatus.

The cells may comprise, e.g., two “C” cells or 2 “D” cells (typically 1.5V each) arranged in series, a 9V cell, etc. Alternatively, a solar collection panel and storage device can be used, so as to obviate at least some of the batteries previously described (e.g., only as emergency or backup when stored solar energy is depleted).

A thumb switch 127 or other actuation mechanism is also disposed on the housing 102 (here, the grip 108) to allow the user to easily activate the light when grasping the apparatus 100. Left-handed models are also envisioned (switch 127 on the other side). Flashlights are well known in the art, and accordingly not described further herein.

Note, however, that the placement of the cells (which typically comprise a fairly heavy weight for their size) low within the housing 102 helps bring the center of gravity lower in the apparatus, thereby acting to stabilize it. Moreover, the placement of the cells low within the housing aids in preventing the light beam emanating from the light 10 from being blocked or impeded by the chemical spray from the nozzle 120, since the two are substantially separated. This also limits “fogging” of the lens by the spray in windy conditions as compared to the case where the nozzle is immediately proximate the light 110.

Further, the weight of the cells acting as a moment or torque around the center of rotation in the vertical plane (i.e., the user's wrist), is at least somewhat offset by the bias force (pulling) on the tether 104 exerted by the animal (i.e., one acts to rotate the apparatus in one direction, and the other in the other direction, thereby at least somewhat offsetting). Specifically, the placement of the tether 104 low in the housing causes a torque or moment around the wrist axis (denoted by crosshairs 129 in FIG. 1d) in a clockwise direction, while the gravitational field vector acting on the batteries (and rest of the apparatus) tends to rotate in the counter-clockwise direction. It will be appreciated, however, that the placement of the tether 104 is not critical, and can in fact be placed e.g., more centrally on the apparatus 100 (see arrow 171 in FIG. 1d), or at the location as shown in FIG. 1a.

Also, the central axes of the light beam from the light 110 and the chemical spray from the nozzle 120 can be made convergent if desired (Φ₁ in FIG. 1d being greater than zero), so that the light and chemical spray are coincidentally placed on the target at maximum leash extension (say 20 feet).

Another embodiment of the apparatus incorporates into the housing 102 a small hand-crank powered generator (magneto or dynamo) that the user can turn to provide electrical power for the light, alarm, and/or other functions. Such magneto or dynamo apparatus are well known in the art (in use on, e.g., human-powered emergency radios), and hence not described further herein. See, e.g., U.S. Pat. No. 6,133,642 to Hutchinson, issued Oct. 17, 2000 entitled “Portable electrical power generating system with mechanical and solar power sources”, which is incorporated herein by reference in its entirety. For example, one variant of the apparatus 100 includes a small storage cell electrically coupled to the output of the generator, which can be charged for short periods of time. Hence, before walking their dog, the user merely flips out the retractable handle of the generator (not shown), gives a few turns on the crank to charge the cell, and then retracts the handle and commences their-walk. Due to natural leakage, use, etc., the cell will discharge over time, requiring the user to utilize the generator again. This approach obviates the use of batteries or rechargeable (removable) cells, which can be costly and have a finite lifetime.

In another embodiment, the apparatus 100 can be configured to include an audible, wireless, and/or visible “alarm” function. For example, in one variant, the alarm comprises an audible alarm that is powered by batteries such as those also used for lighting as shown in FIG. 1d. The light 110 can also be electrically coupled to the alarm logic (described below) so as to energize, modulate (flash), or otherwise active the light coincident with the audible alarm.

In a simple embodiment, the alarm logic merely comprises an alarm switch (e.g., present on the housing 102) that the user can activate when desired. The alarm can also be configured with an optional “dead man” switch function in the one-handed grip such that if the user's hand is separated from the grip for a period of time (e.g., 15 seconds, so as to permit the user to switch hands, etc. without actuating the alarm), the alarm will activate. This functionality is accomplished in one embodiment via an IR or heat sensor, which detects when the grip is being held by a human. In another variant, the aforementioned switching function is implemented using a pressure switch built into the grip portion of the handle apparatus. Other approaches for determining when the grip is engaged by the user can also be implemented.

The alarm function can also be equipped with a “kill” switch, which disables the alarm (either before use—non-permissive mode, or after initiation—to turn off the alarm).

In another alternate configuration (FIG. 1e), the repellant canister 118 is disposed in a cavity 183 formed in the upper portion of the apparatus housing 102. The apparatus further comprises a screw-on (or tab locked) cap 181, which is removable to provide access to the cavity 183 for replacing the canister 118. The cap 181 is also configured to receive the valve tube 184 of the canister therein, such that the cap 181 acts as a bias stop for the tube 184. When the trigger mechanism 116 is actuated (pulled) by the user, the lever portion 180 of the trigger 116 is rotated downward and forward, thereby pressing against the rear (bottom) surface of the canister 118, biasing it forward toward the cap 181 within the cavity 183. As the tube 184 contacts the cap, it is compressed into the canister (akin to pressing down on the spray nozzle of a can of spray paint), thereby allowing the pressurized repellant to flow out the tube 184 and through an orifice in the cap 181, as shown in FIG. 1e.

FIG. 1f illustrates yet another embodiment of the apparatus, wherein the nozzle 120 of the spray tube 122 comprises an adjustable mechanism 140 that allows the user to adjust spray pattern, somewhat akin to the nozzle on a garden hose. As can be appreciated, there may be a need to adjust the spray pattern for the chemical agent dispensed from the nozzle under different circumstances, such as where the target is closer or farther away, whether it is windy or not, density or other properties of the particular chemical agent, etc. In the illustrated embodiment, the metering mechanism 140 comprises a two-position switch which is easily selected by the user (binary—one state or the other), and which provides in a first position (stream) a tightly collimated stream of the chemical agent for maximum range without significant dispersion. In the second position (spray), the agent is dispensed in a shorter range, less collimated pattern (e.g., cone or lobe) that gives more broad coverage at close range. It will be appreciated, however, that any number of discrete or continuous adjustment schemes may be used consistent with the invention (e.g., three-position, continuously variable such as via a metering needle, etc.), as well as other spray or dispensing patterns (fan-shaped, spatter, etc.).

FIG. 1g illustrates another variant of the apparatus 100, here with a webbing material 132 disposed on one or both sides of the housing 102 to restrain, e.g., spare chemical agent canisters 118. This approach allows the user to carry spare canisters in a place that is readily accessible for use. While a web-based material is used in the illustrated embodiment, it will be appreciated that other approaches can be used, such as e.g., forming deflectable snap tabs into the surface of the housing 102 that project outward and allow the spare canisters to be snapped into the housing directly. As yet another alternative, Velcro™ or another comparable material can be used to fasten the canisters to the housing.

The apparatus 100 can further be configured with an automatic ejection mechanism (not shown), such as a button on the grip portion 108 of the embodiment of FIG. 1a, which releases the spent canister 118 within the cavity (such as under the force of gravity of compressed spring force), thereby facilitating rapid reload in the “heat of battle”, akin to many clip-based handguns which have a magazine ejection feature.

FIG. 1h illustrates yet another embodiment of the apparatus 100, wherein a unitary grip form factor is used without a retractable leash or tether. As shown, the apparatus 100 comprises a housing grip portion 190 with an internal cavity 193 for receiving a canister of chemical agent 118. The canister is releasably retained within the housing by, e.g., a user-actuated mechanism 198 at the foot of the housing which captures the canister within the cavity 193, although other approaches may be used with equal success.

The tether 104 is routed through a channel 195 internal to the housing 190, and captured at its distal end within a releasable capture mechanism 197, comprising e.g., a rotating snap tab of other such device for securely capturing the end of the tether. Note that the exit point 196 of the tether 104 at the bottom of the housing 190, as well as the substantially serpentine shape of the internal tether routing channel, cooperate to relieve the capture mechanism 197 from stress. Stated differently, the capture mechanism need not be designed to carry the full stress of the animal on the tether, since this force is dissipated to various portions of the housing 190 by the shape of the channel 195.

The chemical agent is dispended using a standard spray nozzle 191 (which advantageously can be that of the commercially purchased hand-held canister, or if desired one integral with the apparatus 100 as previously described). A safety or cover mechanism 192 is also provided, here a spring-loaded flip-up cover that the user must flip up with their thumb (or other hand) to gain access to the nozzle to depress it. In the illustrated embodiment, the cover and spray nozzle (or actuation mechanism) are advantageously placed so as to permit the user to maintain his/her grasp of the housing, and simultaneously actuate the safety (and subsequently the nozzle) with a single hand.

FIG. 1i illustrates yet another embodiment of the invention, wherein a “triangle” configuration is used for the tether 104 in conjunction with a countered housing 190. This embodiment is generally similar to that of FIG. 1h previously described, yet the tether 104 is captured at or near both ends 198a, 198b of the housing 190, and joined at the apex of the triangle 199 (e.g., stitched together, fused, bonded, etc., or slidably engaged such as via a metal ring) so that both ends of the housing can exert bias on the tether (somewhat akin to a prior art water-skiing rope handle). This attachment or capture of the tether 104 at the ends 198a, 198b of the housing can be accomplished in any number of different ways including, e.g., routing the tether through apertures formed in the housing 190 (as in the illustrated embodiment of FIG. 1i), permanently or removably coupling the tether to rings or eyes that are also coupled to the housing (e.g., wrapping the free end of each segment of the tether through the corresponding ring and then stitching or bonding it, so that it and the ring can rotate relative to one another and the housing), riveting or staking the ends of the tether to the housing, etc.

In still another embodiment (FIG. 1j), the housing is not contoured, but rather merely comprises a substantially round cross-section (as in the aforementioned prior art water-skiing handle) with the chemical agent canister disposed centrally therein, and the tether 104 formed in a triangle configuration as previously described.

It will be appreciated that while described in terms of a restraint apparatus capable of dispensing a chemical agent, various other embodiments of the invention are contemplated which do not make use of a chemical agent (or do so in tandem with other security or repellant apparatus). For example, in one variant, the invention comprises an electrical shock apparatus (e.g., Tazer™ or the like) of the type well known in the art and adapted to fire one or more electrical probes into the target animal and deliver a disabling electrical current. Alternatively, the apparatus can be equipped with electrodes on its surface (or projecting there from) and an internal step-up transformer to deliver high voltage discharge when the electrodes are placed against the animal, akin to an electric cattle prod of the type well known in the art.

The previously described magneto or dynamo can also be used for this purpose; i.e., to supply power to the electrical current delivery apparatus by turning the hand crank.

In still another embodiment, the apparatus 100 may be configured to deliver an electrical charge (current) via the tether 104. In one such variant, the tether comprises a pair of small-gauge, lightweight filaments or wires (akin to those used on the aforementioned Tazer or for wire-guidance of a torpedo (see, e.g., Mk-48 torpedo). The filaments can be, for example, insulated and embedded in the tether or routed along the surface thereof so as to be separated along the length of the tether. When delivery of current is desired, the user actuates a mechanism in the apparatus that places a high potential (e.g., 20,00V) across the conductors, the distal ends of which are coupled to two or more electrodes on the animal's collar. A mechanism in the collar can also be employed to further project the electrodes safely into the animal's skin (especially useful where the animal has a thick coat) to ensure electrical continuity and delivery of the charge to the animal.

In addition to the foregoing features, the apparatus 100 may also be configured with one or more ancillary apparatus, which may be useful to the pet owner including, e.g., plastic bags (and a holder or storage compartment therefor) for policing dog defecation, and so forth.

In one such configuration, the apparatus 100 comprises a global positioning system (GPS) or other comparable receiver adapted for, inter alia, position location of the apparatus and hence the user. Numerous such GPS receivers that are extremely light weight, have low power consumption, and low cost are commercially available and well known to those of ordinary skill, and accordingly not described further herein. Alternatively, other techniques such as triangulation via cellular sites in the area can be used to provide position location. Membership in a WiFi network or association with an AP (access point) may also be used to provide such location information. These position location coordinates or data are used in the present embodiment to comprise an emergency services alert message (e.g., 911) as to the user's location, in the event that the chemical agent or other measures are ineffective, or medical assistance is necessary. The location information can also be used to find an animal which has run away or otherwise been lost by its owner (assuming the tether is attached).

The present invention further contemplates the creation or use of an animal-centric emergency response system effectively parallel to that for humans (e.g., 911). This “doggie-911” would have certain prescribed responders that were tasked with responding to animal-specific emergencies monitor communication channels for such alerts or messages, akin to how a conventional 911 system operates. Hence, when the user of the apparatus 100 activates a communication transceiver on their device, a GPS or other position (“fix” obtained via the GPS constellation, or estimated position) would be determined, and a message formatted for transmission over one or more available communication channels. For example, a first communication channel might comprise the owner's cellular phone. Alternatively, a dedicated satellite uplink could be utilized, akin to OnStar™ or similar automobile navigation or aid systems, or personal locator devices. A dedicated circuit-switched or packet-switched channel (e.g., packet over TCP/IP) could also be established for this purpose, such as via a local WiFi node. The foregoing activate-when-needed approach also obviates large power supplies, since the GPS receiver and communication devices can remain in “sleep” mode, and only power up when needed.

The apparatus 100 may, in another embodiment, communicate with other devices nearby (e.g., the user's cell phone) via a Bluetooth, PAN (802.16) or other short-range wireless interface, the latter device being used to forward the outgoing message or other communication for the apparatus 100.

It will further be appreciated that while previously described in terms of embodiments that allow for selective dispensation and targeting, the apparatus of invention can also be configured as a mass-dispersal unit; i.e., so as to rapidly dispense chemical agent in a less selective manner. For example, in one variant (not shown), the canister (and part of the housing) is detachable from the tether or leash, and includes a one-time actuation feature (“panic button”) such that once actuated, the entire contents of the canister are expelled at a high rate and in multiple directions. This might be effective, inter alia, where several animals are fighting, and a rapid (substantially indiscriminate) dispersal is needed. The user could merely separate the canister from the tether (thereby allowing them to maintain control of their animal after dispensation), activate the panic button, and then toss the canister in proximity of (e.g., into the center of) the group of animals, wherein the broad area dispersal nozzle disperses the chemical agent. In one embodiment, the broad area dispersal nozzle is akin to a unidirectional spray nozzle, except with multi-directional capability, and adapted to substantially atomize the chemical agent upon dispersal, so as to rapidly generate a fairly small radius “cloud” of the chemical agent.

In another embodiment, a non-lethal concussion weapon (e.g., less powerful version of the so-called “flash-bang” commonly used by law enforcement) can be used consistent with the foregoing, so as to add an unpleasant concussive shock and blinding light (in addition to generation of the aforementioned chemical “cloud”. This combination makes for an extremely unpleasant sensory experience for the animals, which can disorient and distract them at least temporarily so as to allow human intervention.

### Methods—

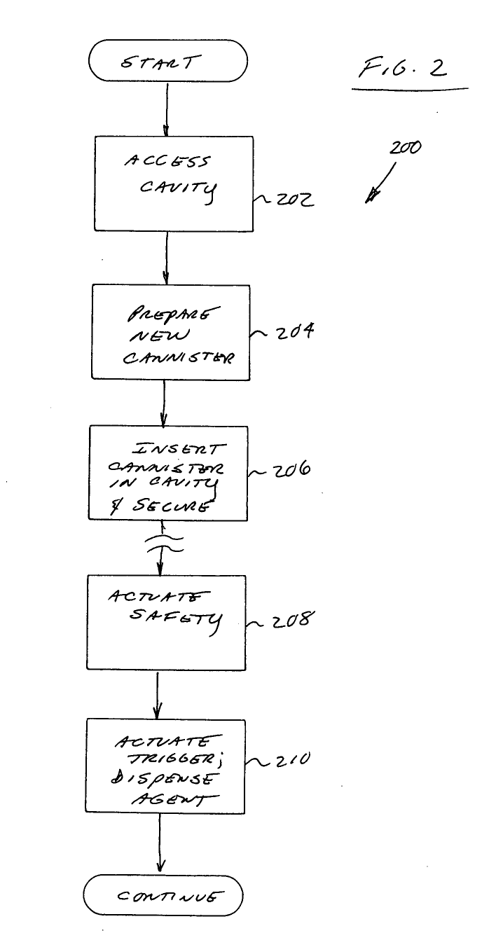

Referring now to FIG. 2, an exemplary embodiment of the method 200 of use is described. In the illustrated embodiment, the user gains access to the cavity within the handle (e.g., by removing door 130, or unscrewing cap 181, etc.) per step 202.

Per step 204, the user prepares the new canister for insertion. Depending on the embodiment of the apparatus 100 in use, this may comprise removing the plastic spray nozzle from the canister to expose the spray tube 184 (as in FIG. 1e), or nothing at all.

Per step 206, the user inserts the prepared canister 118 into the cavity of the apparatus, and secures it therein (e.g., by closing the door 130, screwing on the cap 181, etc.).

Next, when required, the user dispenses the chemical agent by, e.g., actuating the safety mechanism 114 (step 208), and pulling the trigger 116 (step 210).

When depleted, the user replaces the spent canister 118 in similar fashion to steps 202 through 206 previously described.

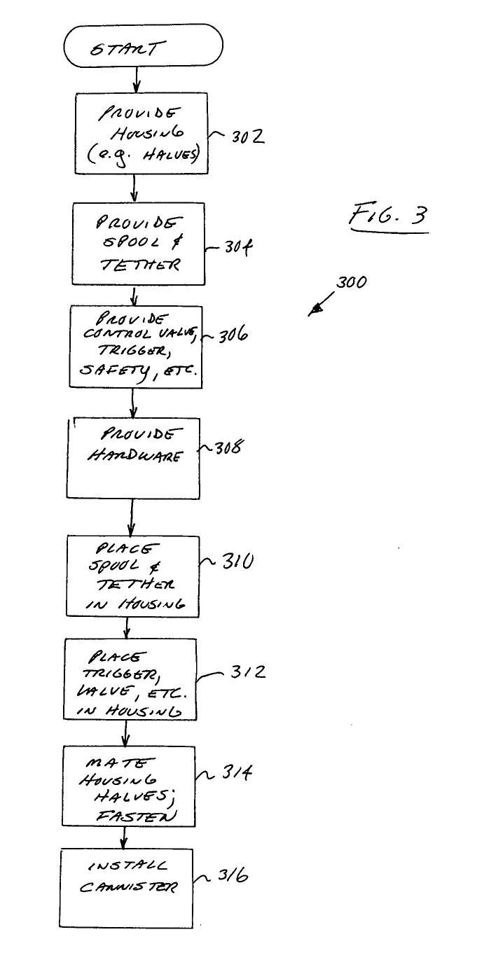

Referring now to FIG. 3, a method of manufacturing the exemplary apparatus 100 of FIG. 1 is described. It will be recognized that while described in terms of the apparatus shown in FIG. 1, the following method may be readily adapted to other embodiments, including those disclosed herein.

Per FIG. 3, the method 300 comprises first providing two halves of the housing element 102 (step 302). A spool mechanism and tether are also provided (step 304), as are the spray tube 122 (and optional nozzle 120), control valve 125, trigger 116, door 130 (if used), and safety mechanism 114 (step 306). Miscellaneous hardware (screws, springs if used, etc.) is also provided (step 308).

Per step 310, the spool mechanism and tether are placed in one half of the separated housing 102. Per step 312, the valve 125, trigger 116, safety 114, and spray tube 122 are placed in the same housing half.

Per step 314, the remaining half of the housing is placed on the first half, and the housing mated (whether by snap-fit, fasteners, adhesives, etc.).

Per step 316, the chemical agent canister is prepared (as necessary) and inserted into the cavity within the housing 102, and the door 130 closed. The apparatus is now ready for use.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the apparatus or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. Animal control apparatus, comprising:
an animal coupling apparatus; and
a chemical agent dispensing mechanism;
wherein at least a portion of each of said coupling apparatus and dispensing mechanism are commonly housed, and can be implemented using a single hand of a user.

2. The apparatus of claim 1, wherein said common housing comprises a pistol grip-like portion having at least one control mechanism disposed thereon and accessible by said single hand of said user, said at least one control mechanism adapted to actuate said chemical agent dispensing mechanism.

3. The apparatus of claim 2, wherein said coupling apparatus comprises a tether that is at least partially retractable onto a spool or reel mechanism.

4. The apparatus of claim 3, wherein said chemical agent comprises at least one of: (i) pepper spray, (ii) mace, and (iii) citronella.

5. The apparatus of claim 1, wherein said common housing comprises a cavity adapted to receive a pressurized canister of said agent, said cavity communicating with said chemical agent dispensing mechanism.

6. The apparatus of claim 6, wherein said chemical agent dispensing mechanism comprises a trigger, safety mechanism, and dispensing nozzle.

7. The apparatus of claim 1, wherein:
said coupling apparatus comprises a leash or tether;
said common housing comprises a longitudinal dimension; and
said dispensing mechanism comprises a nozzle or tube oriented relative to said dimension so as to dispense said chemical agent in a direction substantially parallel with said dimension;
wherein when said leash or tether is under strain by an animal and held in the hand of a user, said strain tends to align said longitudinal dimension of said apparatus and said nozzle or tube with said leash or tether.

8. The apparatus of claim 3, wherein:
said common housing comprises a longitudinal dimension;
said dispensing mechanism comprises a nozzle or tube oriented relative to said dimension so as to dispense said chemical agent in a direction substantially parallel with said dimension; and
said tether is dispensed or retracted generally along said longitudinal dimension;
wherein when said tether is under strain by an animal, said strain tends to align said longitudinal dimension of said apparatus and said nozzle or tube with said tether.

9. The apparatus of claim 1, wherein said coupling apparatus comprises a retractable tether having a payed-out length, and the operation of said dispending mechanism is controlled based at least in part on said payed out length.

10. The apparatus of claim 1, wherein said coupling apparatus comprises a retractable tether having a variable payed-out length, said apparatus further having an optical indication of said payed-out length, said optical indication being useful to said user for determining whether to dispense said chemical agent.

11. The apparatus of claim 10, wherein said optical indication of said payed-out length comprises a color-coding scheme.

12. Animal control apparatus, comprising:
a grip element;
an animal coupling apparatus; and
a chemical agent dispensing mechanism;
wherein at least a portion of each of said coupling apparatus and dispensing mechanism are coupled to said grip element, and both said coupling apparatus and mechanism can be simultaneously implemented using a single hand of a user.

13. The apparatus of claim 12, wherein said coupling apparatus comprises a tether having a forked termination region having first and second ends, said first end being coupled to a first portion of said grip element; (ii) said second end being coupled to a second portion of said grip element, said termination region and said grip element forming a substantially triangular shape.

14. The apparatus of claim 12, wherein said grip element further comprises a cavity, said cavity containing at least a portion of a canister used for storage of said chemical agent.

15. The apparatus of claim 14, wherein said canister comprises said dispensing mechanism, and is replaceable.

16. A method of controlling one or more animals, at least one of said one or more animals being restrained on a leash apparatus, the method comprising selectively dispensing a chemical agent from said leash apparatus toward said one or more animals.

17. The method of claim 16, wherein said leash apparatus comprises a pressurized container of said agent, and said act of selectively dispensing comprises actuating a spray nozzle associated with said pressurized container to spray said agent substantially in a stream toward said one or more animals.

18. The method of claim 16, wherein said leash apparatus comprises:
a tether;
a housing, said housing comprising a longitudinal dimension;
a chemical agent container; and
a dispensing mechanism comprising a nozzle or tube oriented relative to said dimension so as to dispense said chemical agent in a direction substantially parallel with said dimension; and
wherein said method further comprises placing said tether under strain by an animal, said strain aligning said longitudinal dimension of said apparatus and said nozzle or tube with said tether and generally toward said one or more animals.

19. The method of claim 16, wherein said act of selectively dispensing comprises dispensing at two or more animals fighting with one another.

20. The method of claim 19, wherein said chemical agent comprises an agent adapted to provide a unpleasant yet non-permanent sensation for said two or more animals so as to instigate separation thereof.

21. The method of claim 20, wherein said unpleasant yet non-permanent sensation comprises burning of at least one of the eyes, nasal passages, or a mucous membrane.

22. A method of separating two or more engaged animals, at least one of said two or more animals being restrained on a leash apparatus, the method comprising:
selectively generating an electrical potential or current from said leash apparatus; and
applying said generated potential or current to at least one of said two or more animals.

23. The method of claim 22, wherein said act of selectively generating comprises generating using a battery or electrical storage cell associated with said leash apparatus.

24. The method of claim 22, wherein said act of selectively generating comprises generating using a manual electrical generator associated with said leash apparatus.

25. The method of claim 22, wherein said act of applying comprises causing at least one electrode associated with said leash apparatus to contact the skin of at least one of said two or more animals.

26. The method of claim 25, wherein said act of causing at least one electrode associated to contact the skin of at least one of said animals comprises propelling said at least one electrode from said apparatus into contact with said skin of said at least one animal using a propulsive force.

27. The method of claim 25, wherein said at least one electrode is disposed externally on said leash apparatus, and said act of causing at least one electrode to contact the skin of at least one animal comprises placing said apparatus proximate said at least one animal so that said at least one electrode contacts said skin.

28. Animal control apparatus, comprising:
a tether for at least partly restraining an animal;
a handle element coupled to said tether; and
a deterrent mechanism, said deterrent mechanism being detachable from said handle element and adapted for substantially continuous dispensing of a chemical agent.

29. The apparatus of claim 28, wherein said substantially continuous dispensing comprises continuous dispersal of atomized chemical agent from a pressurized canister until said canister is substantially emptied, said continuous dispersal continuing without further human action after initiation thereof.

30. The apparatus of claim 28, wherein said deterrent mechanism further comprises at least one of: (i) a concussive charge; and (ii) a high-intensity luminous flash apparatus.
